(19) United States
(12) Patent Application Publication
(10) Pub. No.: US 2003/0050985 A1
(43) Pub. Date: Mar. 13, 2003

(54) Mail system, mail server and program product for mail server

(76) Inventor: Yuji Shinohara, Toyokawa-Shi (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 10/231,018

(22) Filed: Aug. 30, 2002

(30) Foreign Application Priority Data
Aug. 30, 2001 (JP) 2001-261315

(51) Int. Cl. G06F 15/16

(52) U.S. Cl. 709/206

(57) ABSTRACT

A system including e-mail creation means that creates and sends an e-mail in which a device search word and a search condition specified by the user are included in a recipient area, as well as name resolution means that, when a received e-mail is determined to include a device search word and a search condition, searches for devices that meet the device search word and search condition among the addresses under its management and sends a list of devices obtained from the search to the e-mail creation means.

This application is based on Patent Application No. 2001-261315 filed in Japan, the content of which is hereby incorporated by reference.

### BACKGROUND OF THE INVENTION

1. Field of the Invention

The present invention pertains to a mail system that handles e-mail to which image data is attached.

2. Description of the Related Art

In the conventional art, where image data is to be attached to an e-mail and sent to a printer or the like, image data is created beforehand using a peripheral device such as a scanner, saved to a flexible disk as electronic data and read out from the flexible disk on the user's personal computer, or after the created image data is read out over the network using the user's personal computer, it is attached to an e-mail and sent. In the case of a so-called Internet fax, a mail account (an e-mail address) is stored in the multi-function printer (MFP) having printer, scanner and fax functions, an image is read using the scanner function of this MFP, and the read image data is attached to an e-mail and sent to an e-mail address. In either case, the image data read using a peripheral device is incorporated once and an e-mail is then sent out.

However, in either case, the image data must be incorporated into the personal computer or the MFP and then sent out. Such a method reduces the usable memory of the personal computer or the MFP. Moreover, whenever image data is to be attached, and where it is desired to attach a still image using an MFP or to attach a moving image using a video camera, the user must travel to the remote location where the peripheral device is located, which is inconvenient.

### SUMMARY

An object of the present invention is to enable image data to be incorporated at remote locations using e-mail.

The first system pertaining to the present invention comprises e-mail creation means that creates and sends an e-mail in which a device search word and a search condition specified by the user are included in a recipient area, as well as name resolution means that, when a received e-mail is determined to include a device search word and a search condition, searches for devices that meet the device search word and search condition among the addresses under its management and sends a list of devices obtained from the search to the e-mail creation means.

A second system pertaining to the present invention comprises e-mail creation means that (i) creates an e-mail in which multiple image processing devices specified by the user are designated as forwarding recipients and (ii) includes image retrieval requests for each of the specified forwarding recipients, as well as e-mail forwarding means that, when an e-mail for which multiple image processing devices are specified as forwarding recipients is received, sequentially sets the order in which the e-mail is to be relayed among the multiple image processing devices and sends the e-mail to the first relaying device.

A first program product pertaining to the present invention is a computer-executable program product comprising a step of associating device search words and IP addresses in the name resolution means and registering them in advance, a step of accepting the input of a device search word and a search condition in the e-mail forwarding recipient area via an e-mail creation screen, and a step of creating and sending an e-mail that includes in the forwarding recipient area the accepted device search word and search condition.

A second program product pertaining to the present invention is a computer-executable program product comprising a step of receiving an e-mail, a step of, when it is determined that the received e-mail includes a device search word and a search condition, searching for devices that meet the device search word and search condition among the addresses managed by the name resolution server, and a step of returning to the sender of the e-mail a list of devices obtained from the search in the search step.

A third program product pertaining to the present invention is a computer-executable program product comprising a step of receiving an e-mail, a step of, when an e-mail in which multiple image processing devices are designated as the forwarding recipients and which includes image retrieval requests at the designated forwarding recipients is received, setting a sequential order for the relaying devices, and a step of sending to the first relaying device an image retrieval request intended for at least one relaying device and a request to forward the obtained image information from that relaying device to the next forwarding recipient.

The step of setting a sequential order for the relaying devices preferably includes a step of (i) determining whether the image processing devices specified as forwarding recipients are devices that obtain an image or devices that store or output an image, and (ii) setting devices that obtain or input an image as relaying devices and devices that store or output an image as the final recipients. For example, where it is determined that a peripheral device includes a printer, that printer is specified as the last device for the chain mail. In addition, where an original recipient is specified, the e-mail is sent to that recipient before it is sent to the printer.

These and other objects, advantages and features of the invention will become apparent from the following description thereof taken in conjunction with the accompanying drawings which illustrate specific embodiments of the invention.

### BRIEF DESCRIPTION OF THE DRAWINGS

In the following description, like parts are designated by like reference numbers throughout the several drawings.

FIG. 1 is a drawing showing an e-mail system.

FIG. 2 is a block diagram showing the construction of a sending computer.

FIG. 3 is a block diagram showing the construction of a name resolution server.

FIG. 4 is a block diagram showing the construction of a scanner.

FIG. 5 is a block diagram showing the construction of a printer.

FIG. 6 is a flow chart regarding a client.

FIG. 7 is a flow chart regarding an SMTP server.

FIG. 8 is a flow chart regarding a name resolution server.

FIG. 9 is a flow chart regarding a scanner.

FIG. 10 is a flow chart regarding a printer.

### DESCRIPTION OF THE PREFERRED EMBODIMENTS

An embodiment of the present invention is described below with reference to the accompanying drawings.

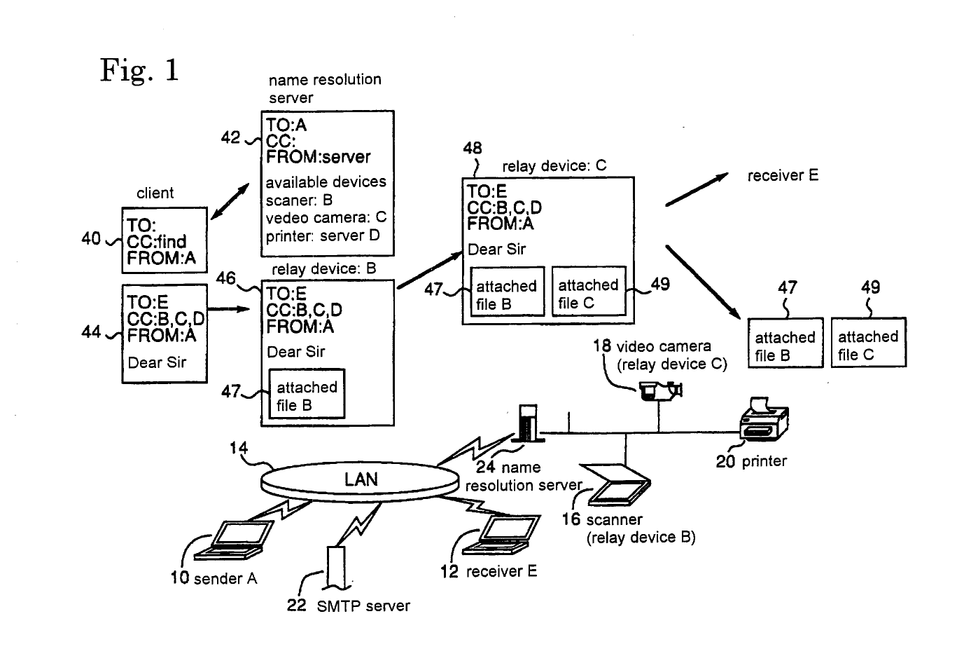

FIG. 1 shows a schematic presentation of a system that sends and receives e-mail. The sending receiver computer 10 and the receiving computer 12 are connected to a LAN 14. A scanner 16, a video camera 18 and a printer 20 are also connected to the LAN 14. An SMTP server (mail server) 22, a name resolution server 24 and the like are connected to the LAN 14 as well. The name resolution server 24 comprises a DNS (domain name system), WINS (Windows Internet Name Service) or other service, and returns the IP address of the computer having a domain name regarding which an inquiry is made.

In this system, when an e-mail is created by the sender, no image is attached thereto, and an image is attached by a relaying device that receives the e-mail prior to the final recipient. The name resolution server 24 automatically searches for image processing peripheral devices that can be used in order to attach an image if the user inputs a search command in the TO, CC or BCC recipient areas for the e-mail. Through this function, available peripheral devices can be efficiently sought and registered. The results of the search are returned in the form of a list.

The user then refers to the received list to specify peripheral device information in one of the recipient areas for the e-mail and sends the e-mail. A job file (an image retrieval request) by which to perform image retrieval via specified relaying devices is attached to the e-mail. When this e-mail is received, the SMTP server (mail server) 22 automatically determines the priority sequence among the relaying peripheral devices. Here it is determined whether the image processing device specified as a forwarding recipient is a device that obtains or inputs an image (such as a scanner or a video camera) or a device that stores or outputs an image (such as a file server or a printer), and a device that obtains or inputs an image is specified as a relaying device, while a device that stores or outputs an image is specified as a final recipient. Chain mailing is then carried out in accordance with the specified relaying device and final recipient. The relaying peripheral devices have an e-mail relaying function. Using this method, an e-mail is relayed via available peripheral devices such that desired image data is incorporated at each relay peripheral device and automatically added to the e-mail, which is then forwarded to the next relaying device. Images are added to the e-mail at each device to which the e-mail is forwarded. One or more images are received at the final recipient, and the received images are stored or output.

Device search words and the IP addresses in the name resolution server 24 are associated and registered beforehand in the SMTP server 22. When an available device search keyword (such as FIND) is input in the TO, CC or BCC recipient area included in the header of an e-mail 40 and the e-mail is sent from the sending computer 10, the SMTP server 22 determines whether or not any of the recipient areas in that e-mail includes a device search keyword. Where it is determined that a device search keyword is included, the SMTP server 22 distributes the e-mail to the name resolution server 24 with priority. When the e-mail 40 and thus the device search keyword are received, the name resolution server 24 automatically searches for devices that are currently capable of providing service in accordance with the search condition and creates a list of such devices. This list is then sent to the sending computer (the requester) 10 via an e-mail 42.

To describe the search for peripheral devices performed by the name resolution server 24, the device search word ‘FIND’ and the IP addresses in the Windows name server (WINS) are associated and registered beforehand in the SMTP server 22. When an e-mail is received that has in the forwarding recipient area the search word ‘FIND’, which requests a search for available devices, the name resolution server (WINS server) 24 searches for devices that the sender may want to use based on the keyword (search condition) of the header information (FIND, DEVICE, PRINTER, SCANNER, etc.) for the e-mail. The results of the search are compiled into the form of a list and returned to the sender 10 via an e-mail 42. Examples of search conditions are shown below.

FIND All addresses managed by WINS

FIND.DEVICE All peripheral device addresses managed by WINS

FIND.PRINTER All printer addresses managed by WINS

FIND.SCANNER All scanner addresses managed by WINS

To describe the manner in which the sending computer 10 selects devices to use, when the list attached to the e-mail 42 is received from the name resolution server 24, the user selects devices to use and inputs them in the CC (recipient to which a copy is to be sent) area of the header of a new e-mail 44. He then inputs a destination address (recipient) in the TO area. In this example, the scanner (B) 16, the video camera (C) 18 and the printer (D) 20 are registered.

This e-mail 44 is received by the SMTP server 22. When it is detected that multiple devices are selected in the CC recipient area, the SMTP server 22 determines that the e-mail is a chain mail, and specifies a sequence for the relaying devices based on the selection information regarding the devices selected as the CC recipients. The SMTP server 22 has the function of sequentially specifying relaying devices based on the device selection information included in the header of the e-mail and adding information that is to be incorporated by each device. Where it is determined that one of the CC recipients is a printer, that device is specified as the last recipient for the chain mail. Therefore, the files that are sequentially added are printed out by that printer at the end of the chain mail. Where a To recipient exists, it is specified as a recipient to receive the e-mail immediately before the printer. Forwarding is performed using the same route at all times by ordinary servers, but in this embodiment, a relay route is selected via automatic determination based on the added special header.

Relaying of the e-mail (chain mailing) is then begun based on the CC recipient addresses. Here each peripheral device has an e-mail relaying function. Where multiple peripheral devices are selected in the CC recipient area, they relay the e-mail according to a prescribed sequence. Multiple images are received by the final recipient, which stores or outputs the received images. In this example, the peripheral devices 16 and 18 automatically add the information (i.e., desired image data) that each incorporates to the e-mails 46 and 48 as attached files. The second peripheral device 18 further attaches a file 49 to the e-mail 48 in addition to the image file 47 incorporated by the scanner 16. Desired image data is automatically added in this way while the e-mail is relayed by the available peripheral devices, whereby the images 47 and 49 are added through the forwarding. The e-mail 48 is sent to the computer 12, which is the TO recipient, as well as to the printer 20, which is the last peripheral device. The printer 20 prints out the two attached files 47 and 49 when the e-mail 48 is received.

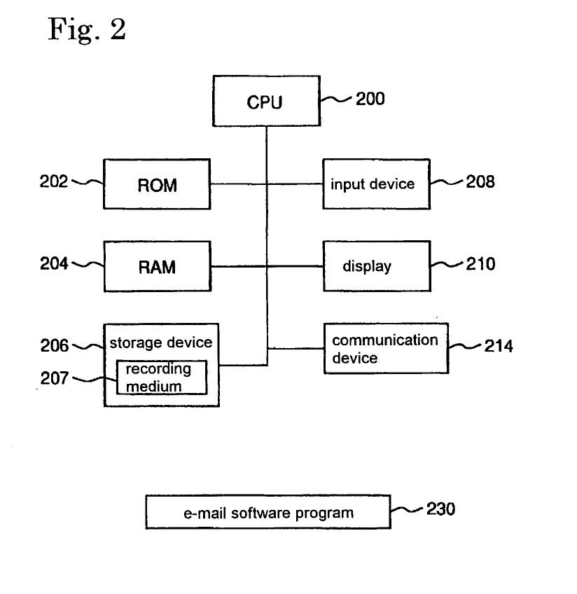

The construction of the sending computer 10 and of the name resolution server 24 will now be described. These have the same components as a normal computer or name resolution server. As shown in FIG. 2, the sending computer 10 includes a CPU 200 that controls the entire apparatus, and connected to the CPU 200 are a ROM 202 that stores programs and data, a RAM 204 that serves as a work area, a storage device 206 comprising a hard disk drive or the like, an input device 208 comprising a keyboard, a mouse or the like, a display device 210 that performs various displays, and a communication device 214 used for communication over an network. An e-mail software program 230, etc. are stored in the hard disk 207 of the hard disk drive.

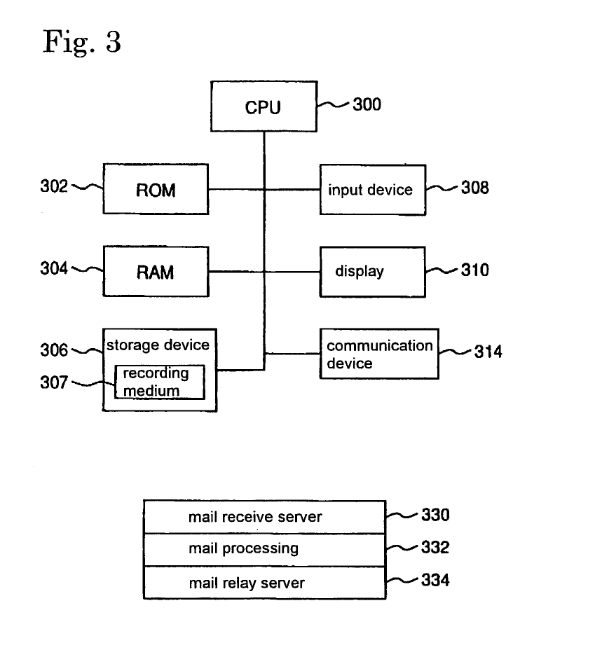

In addition, as shown in FIG. 3, the name resolution server 24 includes a CPU 300 that controls the entire apparatus. Connected to the CPU 300 are a ROM 302 that stores programs and data, a RAM 304 that serves as a work area, a storage device 306 comprising a hard disk drive or the like, an input device 308 comprising a keyboard, a mouse or the like, a display device 310 that performs various displays, and a communication device 314 used for communication over a network. An e-mail receiving server software program 330, an e-mail processing software program 332, an e-mail forwarding server software program 334 and the like are stored on the hard disk 307 of the hard disk drive.

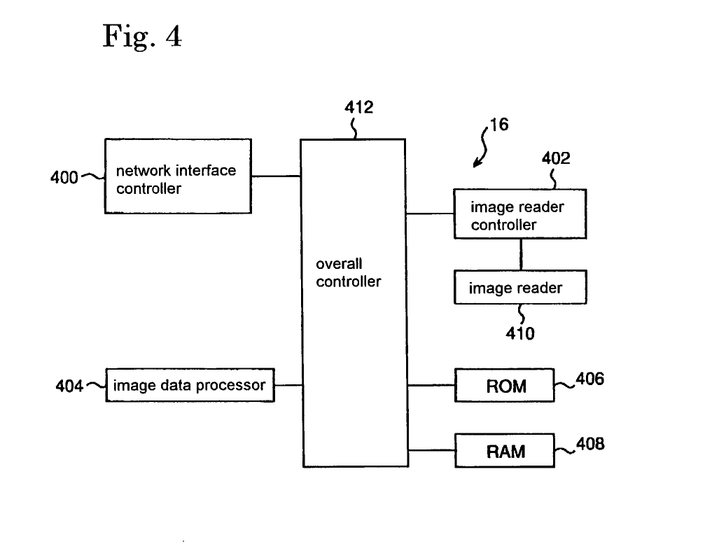

FIG. 4 shows the construction of the scanner 16. The network interface controller 400 controls the communication with external devices. The image reading controller 402 issues instructions such as reading conditions to the image reader 410 and causes it to read images. The image data processor 404 performs processing to convert the electronic data for the read image into a specified file format. The ROM 406 stores the program that controls the scanner 16. The RAM 408 is used as a work area necessary to execute the program that controls the scanner 16. The overall controller 412 performs comprehensive control of the various function blocks 400 through 410.

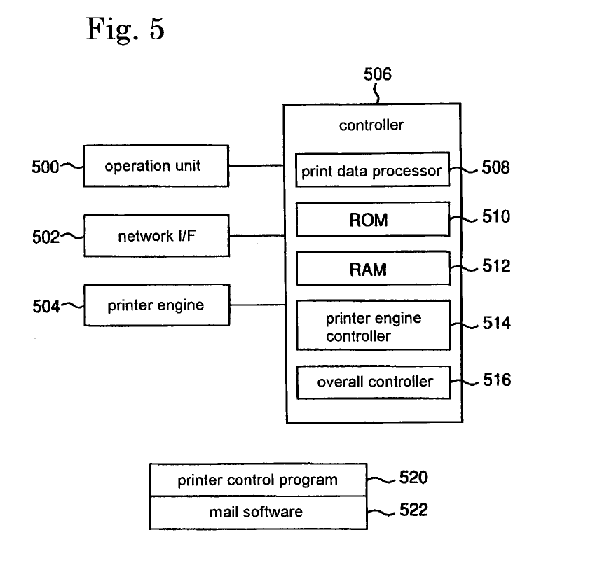

FIG. 5 shows the construction of the printer 20. The printer 20 comprises an operation unit 500 by which to input various commands, a network interface controller 502 that communicates with other devices over the LAN, a printer engine 504 that performs image forming operations, and a controller 506 that controls the printer. The controller 506 comprises a print data processor 508, a ROM 510, a RAM 512, a printer engine controller 514 and an overall controller 516. The printer engine controller 514 controls the printer engine 504. The print data processor 508 processes the received print data. An e-mail software program 522 and the like are stored in the ROM 510 in addition to the program 520 that controls the printer. The RAM 512 is used as a work area necessary for the execution of the program that controls the printer. The overall controller 516 performs comprehensive control of the various function blocks 508 through 514.

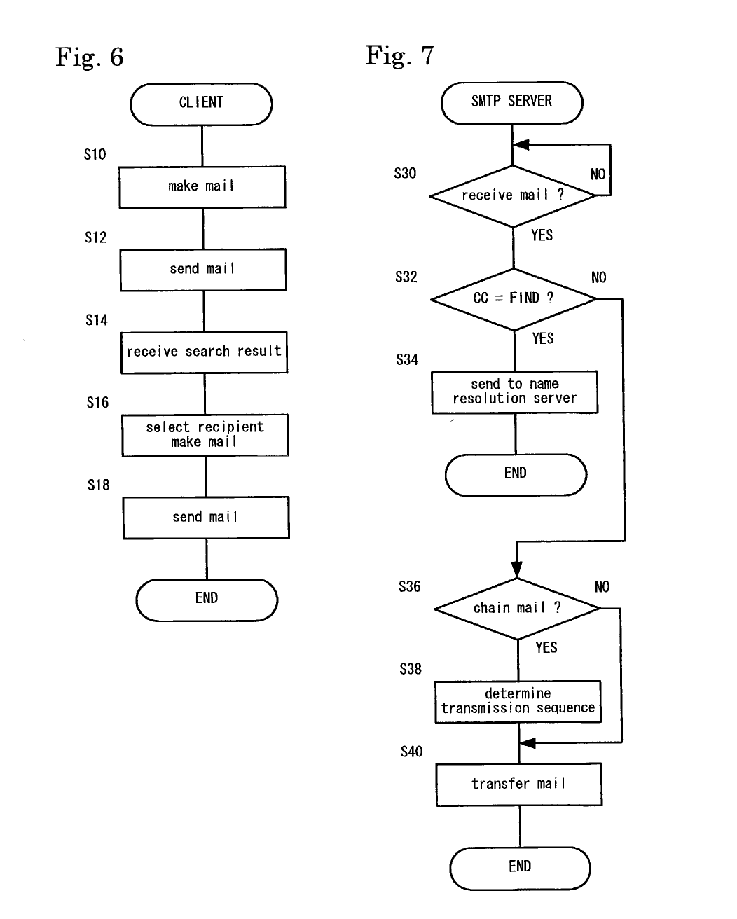

FIG. 6 shows the sequence of the e-mail processing routine performed by the sending computer (client) 10. An e-mail message is created based on the input via a GUI screen (S10), and when a send e-mail command is issued, the e-mail is sent (S12).

FIG. 7 shows the sequence of the e-mail processing routine performed by the SMTP server 22. When an e-mail is received (S30), the SMTP server 22 determines whether or not any of the e-mail recipient areas (TO, CC or BCC) contains a device search keyword (FIND) (S32). If not, normal e-mail transmission is carried out (S36). If any of the e-mail recipient areas contains a device search keyword (FIND), a search request is sent to the name resolution server 24 (S34).

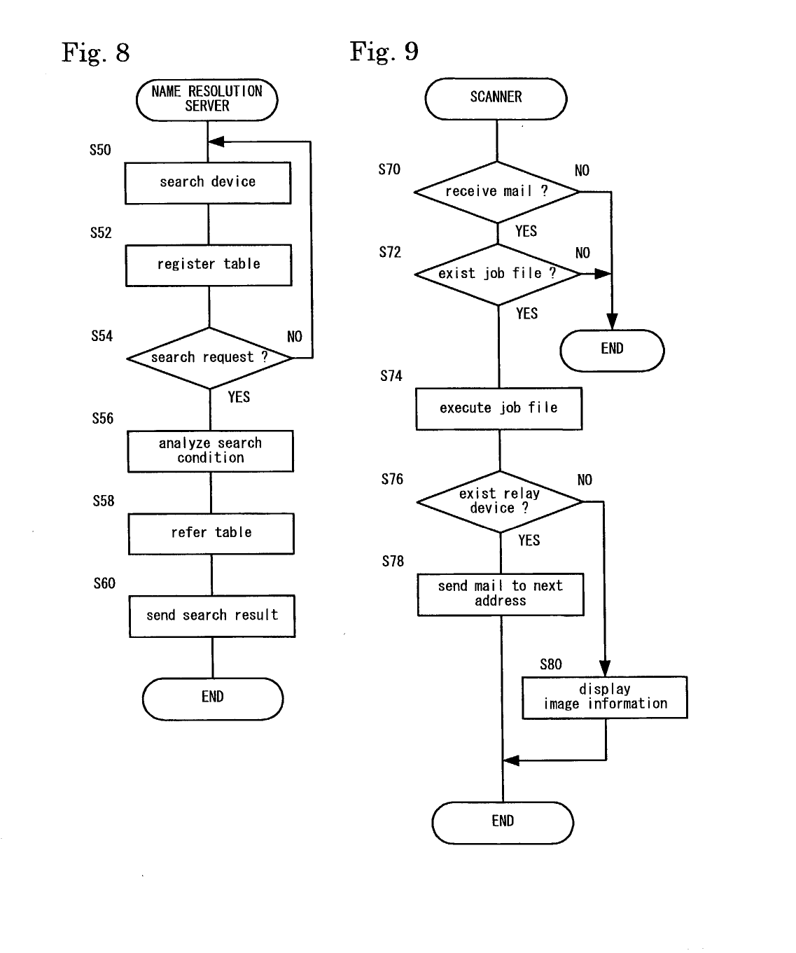

FIG. 8 shows the sequence of the device search routine performed by the name resolution server 24. The devices managed by the name resolution server 24 are first searched (S50) and are registered in a table (S52). Table 1 is one example of such a table.

TABLE 1

| mail account | Attribute |
|---|---|
| device1@AAA.BBB.co.jp | Scanner |
| device2@AAA.BBB.co.jp | printer |
| device3@AAA.BBB.co.jp | server |
| device4@AAA.BBB.co.jp | camera |

When a search request is input (YES in S54), the search condition of that request is analyzed (S56). The table is then referred to, and a mail account (such as device2@AAA.BBB.co.jp) that meets the search condition (such as PRINTER) are extracted (S58). The results of the search are then communicated to the client (S60).

In FIG. 6, when the results of the search are returned to the client 10 from the name resolution server 24 (S14), the user analyzes the results, selects recipients for the e-mail and inputs them in the forwarding recipient area of the header of the e-mail using a GUI screen (S16). The e-mail is then sent (S18).

With reference to FIG. 7, if multiple devices are included in the forwarding recipient area, the SMTP server 22 determines that the e-mail is a chain mail (YES in S36), and specifies the sequence of transmission for the e-mail (S38). For example, where the multiple devices are the scanner 16, a video camera 18 and the printer 20, an e-mail that has the scanner 16, the video camera 18 and the printer 20 in the CC recipient area and the recipient 12 in the TO recipient area is created and forwarded (S40). Where the e-mail is not a chain mail, it is sent to the recipient in the normal manner (S40).

FIG. 9 shows the sequence of the routine performed by the overall controller of the-scanner 16. When an e-mail with a job file is received (YES in S70 and S72), the job file is executed and an image is obtained and attached to the e-mail (S74), whereby a new e-mail is created. In attaching the image, the overall controller waits for it to be read by the scanner, for example. Alternatively, a read image specified by an ID in the job file is attached, for example. It is then determined whether or not a relaying device (the next forwarding recipient) is specified (S76). If yes (the video camera 18 in the example described above), the e-mail is sent to that relaying device (S78), and if not, the e-mail is sent to the TO recipient(s80). In the example described above, an e-mail in which the video camera 18 and the printer 20 are included in the CC recipient area of the header and the recipient 12 is listed in the TO recipient area of the header is created and forwarded.

The video camera 18 performs the same e-mail relay operation as that shown in FIG. 8, but in order to avoid repetition, the description will be omitted here. In the example described above, the CC recipient for the e-mail from the video camera 18 is the printer 20, and the TO recipient is the recipient 12.

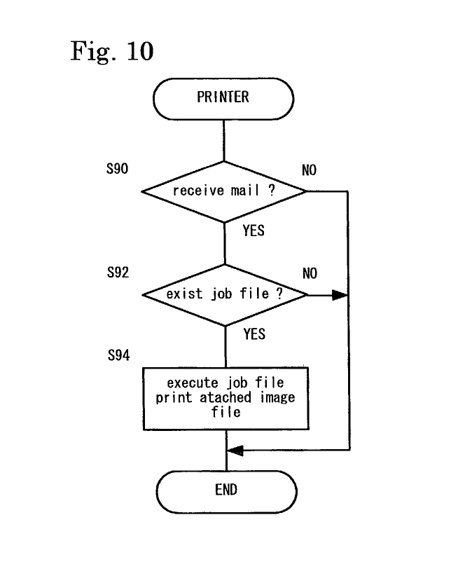

FIG. 10 shows the sequence of the routine performed by the printer 20. When an e-mail to which a job file is attached is received (YES in S90 and S92), the job file is executed and a printing operation is performed for the attached images (S94). In the example described above, two attached files are printed out.

Using the system described above, even if the user who creates an e-mail does not know the addresses of peripheral devices, available peripheral devices can be efficiently sought and registered over a network.

Moreover, the sequence of transmission to the relaying peripheral devices (the sequence by which an e-mail is relayed) is automatically determined from the peripheral device information specified in one of the e-mail recipient areas, and images are incorporated via the relaying devices and automatically attached to the e-mail. A program product includes the program itself as well as the recording medium on which the program is recorded.

Although preferred embodiment of the invention have been described in the foregoing detailed description and illustrated in the accompanying drawings, it will be understood that the invention is not limited to the embodiment disclosed, but is capable of numerous rearrangements, modifications and substitutions of parts and elements without departing from the spirit of the invention. Accordingly, the present invention is intended to encompass such rearrangements, modification and substitutions of parts and elements as fall within the spirit and scope of the invention.

What is claimed is:

1. A mail management system comprising:
an e-mail create portion that creates and sends an e-mail in which a device search word and a search condition are included in a recipient area; and
a name resolution portion that searches for devices that meet the device search word and search condition among the addresses under its management and sends a list of devices obtained from the search to the e-mail create portion.

2. The system according to claim 1, wherein said name resolution portion searches for devices when a received e-mail is determined to include the device search word or the search condition.

3. A mail management system comprising:
an e-mail create portion that creates e-mail in which multiple image processing devices are designated as forwarding recipients; and
an e-mail forwarding portion that sequentially sets the order in which the e-mail is to be relayed among the multiple image processing devices and sends the e-mail to the first relaying device.

4. The system according to claim 3, wherein said e-mail create portion creates e-mail includes image retrieval requests for each of the specified forwarding recipients

5. A program product for allowing a mail crate device to perform mail crating process, said mail crating process comprising the steps of:
accepting the input of a device search word and a search condition in the e-mail forwarding recipient area via an e-mail creation screen, wherein the device search word, the IP address and relationship of them are registered in name resolution means; and
creating and sending an e-mail that includes in the forwarding recipient area the accepted device search word and search condition.

6. A program product for allowing a management server to perform management process, said management process comprising the steps of:
receiving an e-mail;
determining the e-mail includes a device search word and a search condition;
searching for devices that meet the device search word and search condition among the addresses managed by the name resolution server, when the received e-mail includes a device search word and a search condition; and
returning to the sender of the e-mail a list of devices obtained from the search in the search step.

7. A program product for allowing a management server to perform management process, said management process comprising the steps of:
receiving an e-mail;
setting a sequential order for the relaying devices, when an e-mail in which multiple image processing devices are designated as the forwarding recipients and which includes image retrieval requests at the designated forwarding recipients is received; and
sending to the first relaying device an image retrieval request intended for at least one relaying device and a request to forward the obtained image information from that relaying device to the next forwarding recipient.

8. The program product according to claim 7, wherein said step of setting a sequential order for the relaying devices preferably includes a step of (i) determining whether the image processing devices specified as forwarding recipients are devices that obtain an image or devices that store or output an image, and (ii) setting devices that obtain or input an image as relaying devices and devices that store or output an image as the final recipients.

9. The program product according to claim 7, wherein said step of setting a sequential order for the relaying devices preferably includes a step of (i) determining whether the image processing devices includes a printing device, and (ii) setting the printing device as the final recipient.

10. The program product according to claim 7, wherein said step of setting a sequential order, where an original recipient is specified, the e-mail is sent to that recipient before it is sent to the final recipient.
